(19) United States
(12) Patent Application Publication
(10) Pub. No.: US 2023/0302883 A1
(43) Pub. Date: Sep. 28, 2023

(54) DOOR STRUCTURE FOR VEHICLE

(71) Applicant: Honda Motor Co., Ltd., Tokyo (JP)

(72) Inventors: Yasuhisa EGAWA, Tokyo (JP); Yoshihiro Fujimura, Tokyo (JP); Atsushi Hasegawa, Saitama (JP)

(73) Assignee: Honda Motor Co., Ltd., Tokyo (JP)

(21) Appl. No.: 18/166,490

(22) Filed: Feb. 9, 2023

(30) Foreign Application Priority Data
Mar. 23, 2022 (JP) 2022-047660

(51) Int. Cl. B60J 5/04

(52) U.S. Cl. CPC B60J 5/0461; B60J 5/0444

(57) ABSTRACT

A door structure for a vehicle is provided. A door beam includes an arch-shaped beam body in which a center in a longitudinal direction bulges more outward in a vehicle width direction than a front end part and a rear end part attached to an inner panel, and a bracket interposed between the front end part of the beam body and the inner panel. A rigidity of the bracket is lower than a rigidity of the beam body. At least a portion of the inner panel to which the rear end part of the beam body is attached is opposed to a member on a vehicle body side located on the inner side in the vehicle width direction, with a gap in the vehicle width direction being present therebetween.

### CROSS-REFERENCE TO RELATED APPLICATION

This application claims the priority benefit of Japan application serial no. 2022-047660, filed on Mar. 23, 2022. The entirety of the above-mentioned patent application is hereby incorporated by reference herein and made a part of this specification.

### BACKGROUND

### Technical Field

The disclosure relates to a door structure for a vehicle.

### Related Art

For example, Patent Document 1 (Japanese Patent Application Laid-Open No. 2005-138660) has disclosed that a door beam is provided inside a door of a vehicle, and the door beam is formed in an arch shape (curved shape) in which the center in the longitudinal direction of the door beam projects toward the outer side in the vehicle width direction.

In the conventional structure described in Patent Document 1, since the door beam is formed in an arch shape, a load due to a collision (side collision) from the side of the vehicle can be supported by the arch portion of the door beam. Therefore, it is possible to improve the resistance to collisions as compared to a door beam in a straight shape.

A slight gap in the vehicle width direction is provided between the rear end part of the door beam and the center pillar of the vehicle body. Therefore, when the load of a collision (side impact) acts on the door beam, the rear end part of the door beam is first displaced toward the inner side in the vehicle width direction to a position abutting against the center pillar, and then the rear end part is supported by the center pillar.

However, in the conventional structure described in Patent Document 1, since the front end part of the door beam is firmly fixed to the door, the front end part cannot be easily displaced in a rotational direction with respect to the vehicle body. Therefore, since a bending stress acts on the door beam even during displacement of the rear end part of the door beam toward the inner side in the vehicle width direction, the bending strength of the door beam decreases.

### SUMMARY

A door structure for a vehicle according to an embodiment of the disclosure includes an inner panel (20) positioned on an inner side in a vehicle width direction of a vehicle body (10), an outer panel (30) positioned on an outer side of the inner panel (20) in the vehicle width direction, and a door beam (40) provided between the inner panel (20) and the outer panel (30) in the vehicle width direction. The door beam (40) includes an arch-shaped beam body (51) in which a center (51c) in a longitudinal direction bulges more outward in the vehicle width direction than one end part (51a) and another end part (51b) attached to the inner panel (20), and a bracket (70) interposed between the one end part (51a) of the beam body (51) and the inner panel (20). A rigidity of the bracket (70) is lower than a rigidity of the beam body (51). At least a portion of the inner panel (20) to which the another end part (51b) of the beam body (51) is attached is opposed to a member (18) on a vehicle body (10) side located on the inner side in the vehicle width direction, with a gap (L) in the vehicle width direction being present therebetween. The expression “opposed with a gap being present therebetween” herein not only refers to the case where a perfect space is present between the members, but also includes the case where an interfering member such as a flexible sealing rubber material or cushion material is present at the gap.

The above symbols in parentheses indicate, for reference, the drawing reference signs of corresponding constituent elements in the embodiment to be described later.

According to the door structure for a vehicle of the embodiment of the disclosure, with a simple configuration, it is possible to effectively increase a strength of a door beam against a load when a load of a collision acts on the door beam, to thereby suppress decrease in smoothness of traffic of vehicles while improving the safety of traffic.

### BRIEF DESCRIPTION OF THE DRAWINGS

FIG. 1 is a view showing a part of a side surface of a vehicle body to which a door structure for a vehicle according to an embodiment of the disclosure is applied.

FIG. 2 is a schematic perspective view of a door beam viewed from above.

FIG. 3 is a cross-sectional view taken along line X-X in FIG. 1.

FIG. 4 is a view showing a detailed configuration of a front end part of a door beam and its vicinity, and is a partially enlarged view of a Y portion in FIG. 2.

FIG. 5 is a perspective view showing a detailed configuration of the front end part of the door beam and its vicinity.

FIG. 6 is a view illustrating the action of a bracket.

### DESCRIPTION OF THE EMBODIMENTS

An embodiment of the disclosure provides a door structure for a vehicle which, despite its relatively simple configuration, is capable of effectively increasing a strength of a door beam against a load when a load of a collision acts on the door beam, to thereby suppress decrease in smoothness of traffic of vehicles while improving the safety of traffic.

A door structure for a vehicle according to an embodiment of the disclosure includes an inner panel (20) positioned on an inner side in a vehicle width direction of a vehicle body (10), an outer panel (30) positioned on an outer side of the inner panel (20) in the vehicle width direction, and a door beam (40) provided between the inner panel (20) and the outer panel (30) in the vehicle width direction. The door beam (40) includes an arch-shaped beam body (51) in which a center (51c) in a longitudinal direction bulges more outward in the vehicle width direction than one end part (51a) and another end part (51b) attached to the inner panel (20), and a bracket (70) interposed between the one end part (51a) of the beam body (51) and the inner panel (20). A rigidity of the bracket (70) is lower than a rigidity of the beam body (51). At least a portion of the inner panel (20) to which the another end part (51b) of the beam body (51) is attached is opposed to a member (18) on a vehicle body (10) side located on the inner side in the vehicle width direction, with a gap (L) in the vehicle width direction being present therebetween. The expression “opposed with a gap being present therebetween” herein not only refers to the case where a perfect space is present between the members, but also includes the case where an interfering member such as a flexible sealing rubber material or cushion material is present at the gap.

According to the door structure for a vehicle of the embodiment of the disclosure, when a load of a collision (side collision) acts on the door beam (beam body), first, the another end part of the beam body is displaced toward the inner side in the vehicle width direction to a position abutting against the member (center pillar) on the vehicle body side. At this time, with the deformation of the bracket interposed between the one end part of the beam body and the inner panel, the beam body can be displaced in a rotational direction around the one end part. Accordingly, since no bending stress acts on the beam body until the another end part of the beam body is supported by the opposing member on the vehicle body side, it is possible to effectively prevent the bending strength of the beam body from decreasing. Therefore, when the load of a collision acts on the door beam, the strength of the door beam against the load can be effectively increased with a simple configuration.

Further, in this door structure, the bracket (70) may be a member interposed between a front end part (51a) of the beam body (51) and the inner panel (20). The bracket (70) may include a first joint surface (71a) joined to the inner panel (20), a second joint surface (72a) to which the front end part (51a) of the beam body (51) is joined, and a connecting surface (73a) arranged in a plane in the vehicle width direction of the vehicle body (10) and connecting the first joint surface (71a) and the second joint surface (72a). The connecting surface (73a) may be formed in a shape in which a length in the vehicle width direction gradually increases from a front side toward a rear side of the vehicle body (10).

In this case, the connecting surface (73a) of the bracket (70) may be formed in a triangular shape including a first side (74a) connected to the first joint surface (71a) and a second side (74b) connected to the second joint surface (72a), and a distance between the first side (74a) and the second side (74b) may gradually increase from the front side toward the rear side of the vehicle body (10).

According to these configurations, since the distance between the first joint surface and the second joint surface is greater on the rear side than on the front side of the connecting surface of the bracket, when a load of a collision (side collision) acts on the door beam, with the deformation of the connecting surface of the bracket, the beam body is displaced in the rotational direction around the front end part. Therefore, it is possible to more reliably prevent a bending stress from occurring in the beam body immediately after the load of the collision (side collision) acts on the door beam.

Further, in this door structure, a reinforcing member (60) which reinforces the second joint surface (72a) of the bracket (70) may be provided between the second joint surface (72a) and the beam body (51).

According to this configuration, since it is possible to prevent the second joint surface of the bracket from deforming earlier than the connecting surface by providing the reinforcing member which reinforces the second joint surface of the bracket, when a load of a collision (side collision) acts on the door beam, the beam body is displaced in the rotational direction around the front end part more reliably and from an earlier stage.

Further, in this door structure, the front end part (51a) of the beam body (51) may be a straight part extending in a straight shape toward the rear side, a curve part (52a) in a curved shape which bulges toward the outer side in the vehicle width direction may be connected to a rear side of the front end part (51a) in the beam body (51), and the bracket (70) may be attached to the front end part (51a).

According to this configuration, since the front end part, which is the straight part, of the beam body abuts against (contacts) the inner panel when the bracket is deformed, the front end part, which is the straight part, comes into planar contact with the inner panel and is supported by the vehicle body side. Therefore, it is possible to further increase the reaction force of the beam body after the bracket is deformed.

Further, in this door structure, at least a portion of the inner panel (20) to which the bracket (70) is attached may be opposed to a front pillar (17) which is a member on the vehicle body (10) side located on the inner side in the vehicle width direction, and the front end part (51a) of the beam body (51) may be provided at a position opposed to the front pillar (17) via the inner panel (20).

According to this configuration, when the beam body is displaced in the rotational direction around the front end part due to the deformation of the bracket, since the front end part, which is the straight part, of the beam body comes into planar contact with the front pillar via the inner panel, the front end part of the beam body can be more reliably supported by the front pillar, which is a member on the vehicle body side. Therefore, it is possible to further increase the reaction force of the beam body after the bracket is deformed.

The above symbols in parentheses indicate, for reference, the drawing reference signs of corresponding constituent elements in the embodiment to be described later.

According to the door structure for a vehicle of the embodiment of the disclosure, with a simple configuration, it is possible to effectively increase a strength of a door beam against a load when a load of a collision acts on the door beam, to thereby suppress decrease in smoothness of traffic of vehicles while improving the safety of traffic.

Hereinafter, an embodiment of the disclosure will be described in detail with reference to the accompanying drawings. In the following description, the term “front” or “rear” refers to the front side, i.e., the forward direction, or the rear side, i.e., the backward direction, of a vehicle body (vehicle) (to be described later). Further, “left” and “right” respectively refer to left and right in the vehicle width direction when facing the forward direction (front side) of the vehicle body (vehicle). Further, the terms “up” and “down” refer to the up-down direction (vertical up-down direction) of the vehicle body (vehicle).

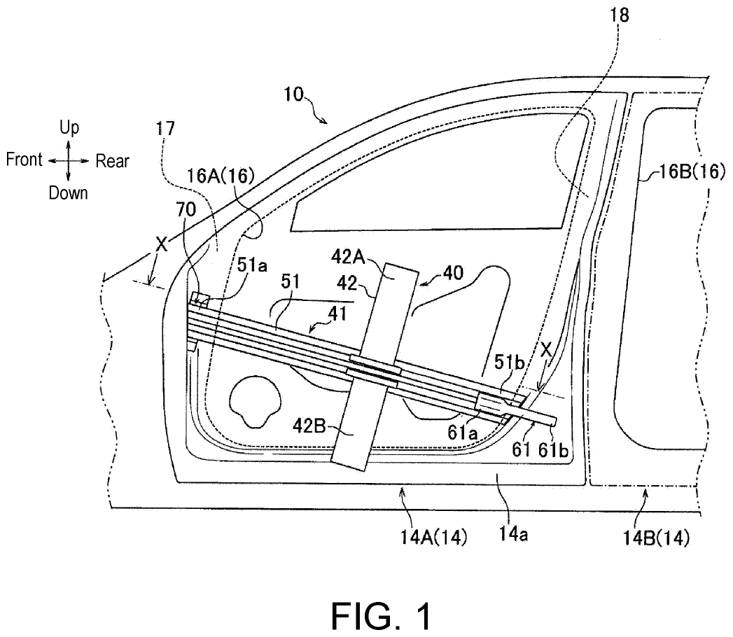

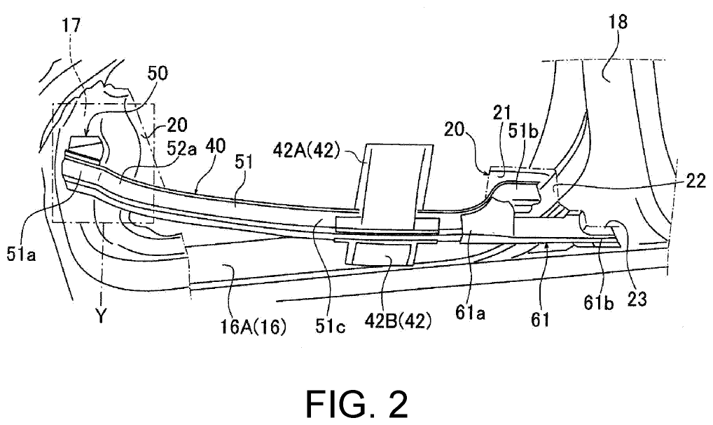

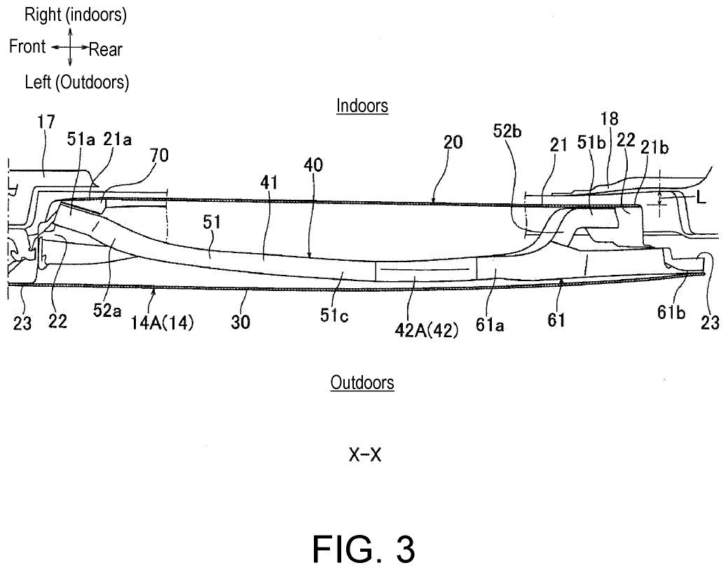

FIG. 1 is a view showing a part of a side surface of a vehicle body to which a door structure for a vehicle according to an embodiment of the disclosure is applied. FIG. 2 is a schematic perspective view of a door beam viewed from above. FIG. 3 is a cross-sectional view taken along line X-X in FIG. 1. As shown in these figures, the vehicle to which the door structure according to the embodiment of the disclosure is applied includes a side door 14 provided on a vehicle body 10. The side door 14 is composed of a front door 14A and a rear door 14B. The vehicle body 10 is provided with a door opening 16 to which the side door 14 is attached in an openable and closable manner. The door opening 16 includes a front door opening 16A and a rear door opening 16B. A front pillar (member on the vehicle body side) 17 extending in a substantially up-down direction is provided on the front side of the front door opening 16A of the vehicle body 10. A center pillar (member on the vehicle body side) 18 that similarly extends in a substantially up-down direction is provided on the rear side of the front door opening 16A. In the following description, of the side door 14 and the door opening 16, only the front door 14A and the front door opening 16A will be described, and descriptions of the rear door 14B and the rear door opening 16B will be omitted.

The front door 14A is formed of a door body 14a that opens and closes the front door opening 16A. As shown in FIG. 3, the door body 14a of the front door 14A includes an inner panel 20 provided on the inner side (indoor side) in the vehicle width direction, an outer panel 30 provided on the outer side (outdoor side) of the inner panel 20 in the vehicle width direction, and a door beam 40 provided between the inner panel 20 and the outer panel 30 in the vehicle width direction. The inner panel 20 and the outer panel 30 are plate-shaped members made of metal, and the door beam 40 is an elongated member made of metal.

The door beam 40 is composed of a horizontal beam 41 that is disposed inside the door body 14a of the front door 14A and extends along the front-rear direction of the vehicle body 10, and a vertical beam 42 that is also disposed inside the door body 14a and extends along the up-down direction of the vehicle body 10.

The horizontal beam 41 includes an arch-shaped beam body 51 in which a central part 51c in the longitudinal direction bulges more outward in the vehicle width direction than a front end part 51a and a rear end part 51b, and a stay 61 connected to the vicinity of the rear end part 51b of the beam body 51. The beam body 51 is an elongated member having a substantially U-shaped cross-section projecting toward the outer side in the vehicle width direction, and the front end part 51a and the rear end part 51b of the beam body 51 form fixing parts fixed to the inner panel 20. With the vicinities of the front end part 51a and the rear end part 51b respectively forming a front curved part 52a and a rear curved part 52b that curve toward the outer side in the vehicle width direction, the central part 51c in the longitudinal direction forms a shape bulging toward the outer side in the vehicle width direction. The stay 61 is similarly an elongated member having a substantially U-shaped cross-section projecting toward the outer side in the vehicle width direction, and the entire stay 61 in the longitudinal direction from a front end part 61a to a rear end part 61b of the stay 61 is formed in a substantially straight shape. In this embodiment, the cross sections the entire beam body 51 and the entire stay 61 in the longitudinal direction are both formed in a substantially U-shape.

The vertical beam 42 is coupled to a portion of the beam body 51 that bulges most outward in the vehicle width direction in a plan view. The vertical beam 42 is composed of an upper vertical beam 42A extending from the beam body 51 toward the upper side, and a lower vertical beam 42B extending from the beam body 51 toward the lower side.

In the door structure of this embodiment, the inner panel 20 includes an inner wall (first wall) 21 extending in the front-rear direction of the vehicle body 10 on the inner side in the vehicle width direction, a connecting wall (second wall) 22 extending from the inner wall 21 toward the outer side in the vehicle width direction, and an outer wall (third wall) 23 extending in the front-rear direction of the vehicle body 10 from the outer end of the connecting wall 22 in the vehicle width direction and joined to the outer panel 30. The inner wall 21 is a portion forming the inner side of the inner panel 20 excluding the outer edge (outer peripheral edge). The outer wall 23 is a portion forming the outer edge (outer peripheral edge) of the inner panel 20. The inner wall 21 and the outer wall 23 are respectively arranged in a plane positioned on the inner side (right side in FIG. 3 or indoor side) and in a plane positioned on the outer side (left side in FIG. 3 or outdoor side) in the vehicle width direction. The connecting wall 22 connects the inner wall 21 and the outer wall 23 with a step therebetween in the vehicle width direction.

As shown in FIG. 3, the front end part 51a of the beam body 51 is fixed to the inner wall 21 of the inner panel 20. The portion of the inner panel 20 to which the front end part 51a of the beam body 51 is fixed is opposed to the front pillar 17 located on the inner side in the vehicle width direction.

As shown in FIG. 3, the rear end part 51b of the beam body 51 is fixed to the inner wall 21 of the inner panel 20. The front end part (one end part) 61a of the stay 61 is fixed at a position between the vertical beam 42, and the rear end part 51b and the rear curved part 52b of the beam body 51. The rear end part (another end part) 61b of the stay 61 is fixed to the outer wall 23 of the inner panel 20. The portion of the inner panel 20 to which the rear end part 51b of the beam body 51 is fixed is opposed to the center pillar 18 (more specifically, the vicinity of a lower end part of the center pillar 18) located on the inner side in the vehicle width direction.

Further, as shown in FIG. 3, with the front door 14A being closed, a slight gap L (clearance) in the vehicle width direction is present between the rear end part 51b (specifically, the portion of the inner panel 20 to which the rear end part 51b of the beam body 51 is attached) of the door beam 40 (beam body 51) and the center pillar 18. The gap L is not a perfect space, and in fact, an interfering member (not shown) such as a flexible sealing rubber material or cushion material is present at the gap L. That is, as long as the center pillar 18 and the portion of the inner panel 20 to which the rear end part 51b of the beam body 51 is attached are opposed to each other without a highly rigid component such as a metal member interposed therebetween, “a gap L is present” herein also includes the case where the center pillar 18 and the portion of the inner panel 20 are opposed to each other via an elastic or flexible member such as a rubber material or a cushion material.

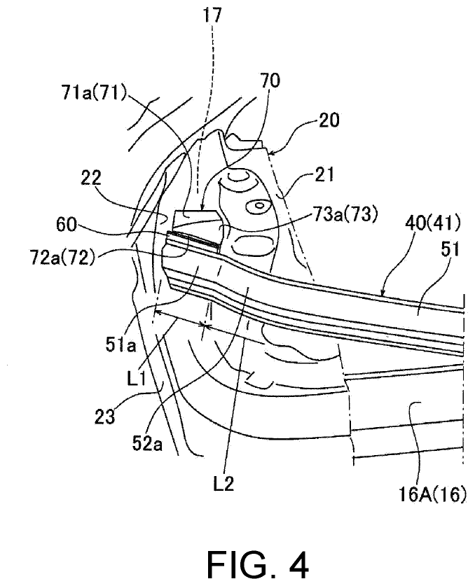

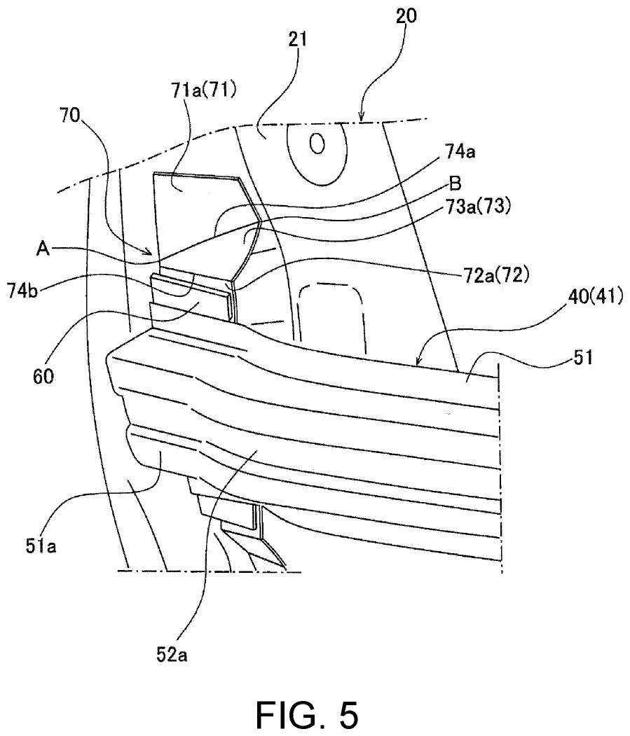

FIG. 4 is a view showing a detailed configuration of the front end part of the door beam (beam body) and its vicinity, and is a partially enlarged view of a Y portion in FIG. 2. In this embodiment, a bracket 70 is interposed between the front end part 51a of the beam body 51 and the inner panel 20. FIG. 5 is a view illustrating a configuration of the bracket, and is a perspective view showing the configuration of the front end part of the door beam (beam body) and its vicinity. As shown in FIG. 5, the bracket 70 is a member formed by bending a metal plate, and includes a first wall 71 having a first joint surface 71a joined to the inner panel 20, a second wall 72 having a second joint surface 72a to which the front end part 51a of the beam body 51 is joined, and a connecting wall 73 having a connecting surface 73a arranged in a plane in the vehicle width direction of the vehicle body 10 and connecting the first wall 71 (first joint surface 71a) and the second wall 72 (second joint surface 72a). Accordingly, a cross section of the bracket 70 in the front-rear direction is formed in a substantially U-shape. That is, the first wall 71 is provided at each of the upper end and the lower end of the bracket 70, the second wall 72 is provided at a middle part in the up-down direction of the bracket 70, the connecting wall 73 connected to the upper-side first wall 71 is connected to an upper edge of the second wall 72, and the connecting wall 73 connected to the lower-side first wall 71 is connected to a lower edge of the second wall 72. Accordingly, the bracket 70 is formed as a member having a substantially U-shaped cross section in which substantially the entire second wall 72 projects more outward in the vehicle width direction than the first wall 71. Further, the rigidity of the bracket 70 is lower than the rigidity of the door beam 40.

As shown in FIG. 5, the connecting wall 73 (connecting surface 73a) of the bracket 70 is formed in a triangular shape including a first side 74a connected to the first wall 71 (first joint surface 71a) and a second side 74b connected to the second wall 72 (second joint surface 72a), and a distance between the first side 74a and the second side 74b gradually increases from the front side toward the rear side of the vehicle body 10. That is, the connecting wall 73 (connecting surface 73a) is formed in a shape in which the length in the vehicle width direction gradually increases from the front side toward the rear side of the vehicle body 10.

As shown in FIG. 4, the front end part 51a (in the range of an arrow L1) of the beam body 51 is a straight part extending in a straight shape toward the rear side, and the front curved part (curve part) 52a in a curved shape which bulges toward the outer side in the vehicle width direction is connected to the rear side (in the range of an arrow L2) of the front end part 51a of the beam body 51. The bracket 70 is attached to the front end part 51a, which is the straight part, of the beam body 51.

A reinforcing member 60 that reinforces the second wall 72 (second joint surface 72a) of the bracket 70 is provided between the second wall 72 (second joint surface 72a) of the bracket 70 and the beam body 51. The reinforcing member 60 is a plate-shaped member made of metal and is interposed between the front end part (straight part) 51a of the beam body 51 and the second wall 72 (second joint surface 72a) of the bracket 70. The thickness dimension of the reinforcing member 60 may be equal to or greater than the thickness dimension of the plate material forming the bracket 70. Further, the reinforcing member 60 may have a rigidity higher than the rigidity of the bracket 70.

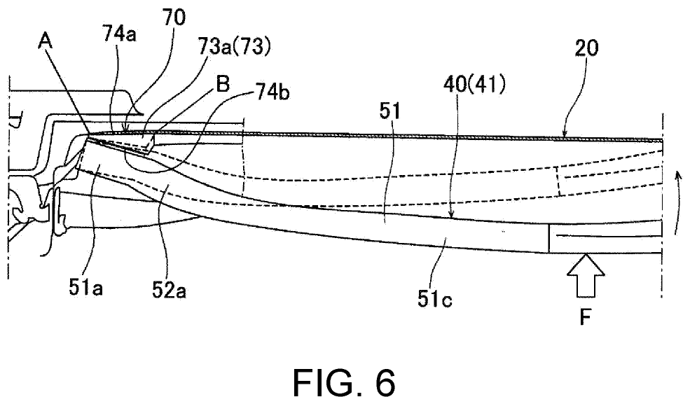

Next, the action of the door structure having the above configuration will be described. FIG. 6 is a view illustrating the action of the bracket. As described above, with the front door 14A being closed, a slight gap L (clearance) in the vehicle width direction is present between the rear end part 51b (inner panel 20) of the door beam 40 (beam body 51) and the center pillar 18 (see FIG. 3).

As shown in FIG. 6, at the time of a collision (side collision) with the side surface of the vehicle, in the case where a load F of the collision (side collision) acts on the center or its vicinity of the beam body 51 in the longitudinal direction, first, as indicated by dotted lines in FIG. 6, the rear end part 51b of the beam body 51 is displaced toward the inner side in the vehicle width direction to a position abutting against the center pillar 18. At this time, with the deformation of the connecting wall 73 of the bracket 70 interposed between the front end part 51a of the beam body 51 and the inner panel 20, the beam body 51 can be displaced in a rotational direction around the front end part 51a. At this time, the force acting on the bracket 70 (connecting wall 73) from the front end part (straight part) 51a of the beam body 51 acts by taking a front-side vertex A, which is an intersection point between the first side 74a and the second side 74b of the connecting wall 73 shown in FIG. 6, as a supporting point, and taking a rear-side vertex B of the first side 74a as an acting point. With the connecting wall 73 of the bracket 70 being deformed by this force, no bending stress acts on the beam body 51 until the rear end part 51b (specifically, the inner panel 20 to which the rear end part 51b is attached) of the beam body 51 abuts against the center pillar 18. Therefore, it is possible to effectively prevent the bending strength of the beam body 51 from decreasing. Therefore, when a load F of a collision (side collision) acts on the door beam 40, the strength of the door beam 40 against the load F can be effectively increased.

After the rear end part 51b (specifically, the inner panel 20 to which the rear end part 51b is attached) of the beam body 51 abuts against the center pillar 18, if the load F of the collision (side collision) continues to act on the door beam 40, as the bending stress acts on the beam body 51, the beam body 51 begins to bend. Accordingly, although the connecting wall 73 of the bracket 70 is further deformed, eventually the front end part 51a (straight part) of the beam body 51 comes into planar contact with the front pillar 17 via the inner panel 20. Accordingly, the front end part 51a (straight part) of the beam body 51 can be more reliably supported by the front pillar 17, which is a member on the vehicle body 10 side. Therefore, it is possible to further increase the reaction force of the door beam 40 after the bracket 70 is deformed.

As described above, the door structure of this embodiment includes the inner panel 20 positioned on the inner side in the vehicle width direction, the outer panel 30 positioned on the outer side of the inner panel 20 in the vehicle width direction, and the door beam 40 provided between the inner panel 20 and the outer panel 30 in the vehicle width direction. The door beam 40 includes the arch-shaped beam body 51 in which the center part 51c in the longitudinal direction bulges more outward in the vehicle width direction than the front end part 51a and the rear end part 51b attached to the inner panel 20, and the bracket 70 interposed between the front end part 51a of the beam body 51 and the inner panel 20. The rigidity of the bracket 70 is lower than the rigidity of the door beam 40 (beam body 51). At least the portion of the inner panel 20 to which the rear end part 51b of the beam body 51 is attached is opposed to the center pillar (member on the vehicle body 10 side) 18 located on the inner side in the vehicle width direction, with the gap L in the vehicle width direction being present therebetween.

According to this door structure, when a load of a collision (side collision) acts on the door beam 40, first, the rear end part 51b of the door beam 40 (beam body 51) is displaced toward the inner side in the vehicle width direction to a position abutting against the center pillar 18. At this time, with the deformation of the bracket 70 interposed between the front end part 51a of the beam body 51 and the inner panel 20, the beam body 51 can be displaced in a rotational direction around the front end part 51a. Accordingly, since no bending stress acts on the beam body 51 until the rear end part 51b of the beam body 51 is supported by the opposing center pillar 18, it is possible to effectively prevent the bending strength of the beam body 51 from decreasing. Therefore, when the load of a collision acts on the door beam 40, the strength of the door beam 40 against the load can be effectively increased with a simple configuration.

Further, in the door structure of this embodiment, the bracket 70 is a member interposed between the front end part 51a of the beam body 51 and the inner panel 20. The bracket 70 includes the first joint surface 71a joined to the inner panel 20, the second joint surface 72a to which the front end part 51a of the beam body 51 is joined, and the connecting surface 73a arranged in a plane in the vehicle width direction of the vehicle body 10 and connecting the first joint surface 71a and the second joint surface 72a.

The connecting surface 73a of the bracket 70 is formed in a triangular shape including the first side 74a connected to the first joint surface 71a and the second side 74b connected to the second joint surface 72a, and the distance between the first side 74a and the second side 74b gradually increases from the front side toward the rear side of the vehicle body 10. Accordingly, the connecting surface 73a is formed in a shape in which the length in the vehicle width direction gradually increases from the front side toward the rear side of the vehicle body 10.

According to this configuration, since the distance between the first joint surface 71a and the second joint surface 72a is greater on the rear side than on the front side of the connecting surface 73a of the bracket 70, when a load of a collision (side collision) acts on the door beam 40 (beam body 51), with the deformation of the connecting surface 73a of the bracket 70, the beam body 51 is displaced in the rotational direction around the front end part 51a. Therefore, it is possible to more reliably prevent a bending stress from occurring in the beam body 51 immediately after the load of the collision (side collision) acts on the door beam 40.

Further, in the door structure of this embodiment, the reinforcing member 60 which reinforces the second joint surface 72a is provided between the second joint surface 72a of the bracket 70 and the beam body 51.

According to this configuration, since it is possible to prevent the second joint surface 72a of the bracket 70 from deforming earlier than the connecting surface 73a by providing the reinforcing member 60 which reinforces the second joint surface 72a of the bracket 70, when a load of a collision (side collision) acts on the door beam 40, the beam body 51 is displaced in the rotational direction around the front end part 51a more reliably and from an earlier stage.

Further, in the door structure of this embodiment, the front end part 51a of the beam body 51 is a straight part extending in a straight shape toward the rear side. The front curved part 52a, which is a curve part in a curved shape that bulges toward the outer side in the vehicle width direction, is connected to the rear side of the front end part 51a in the beam body 51. The bracket 70 is attached to the front end part 51a, which is the straight part.

According to this configuration, since the front end part 51a, which is the straight part, of the beam body 51 abuts against (contacts) the inner panel 20 when the bracket 70 is deformed, the front end part 51a comes into planar contact with the inner panel 20 and is supported by the vehicle body side. Therefore, it is possible to further increase the reaction force of the beam body 51 after the bracket 70 is deformed.

Further, in the door structure of this embodiment, at least the portion of the inner panel 20 to which the bracket 70 is attached is opposed to the front pillar (member on the vehicle body 10 side) 17 located on the inner side in the vehicle width direction. The front end part 51a, which is the straight part, of the beam body 51 is provided at a position opposed to the front pillar 17 via the inner panel 20.

According to this configuration, when the beam body 51 is displaced in the rotational direction around the front end part 51a due to the deformation of the bracket 70, since the front end part 51a, which is the straight part, of the beam body 51 comes into planar contact with the front pillar 17 via the inner panel 20, the front end part 51a of the beam body 51 can be more reliably supported by the front pillar 17, which is a member on the vehicle body 10 side. Therefore, it is possible to further increase the reaction force of the beam body 51 after the bracket 70 is deformed.

Although the embodiment of the disclosure has been described above, the disclosure is not limited to the above embodiment, and various modifications are possible within the scope of the technical ideas described in the claims, specification, and drawings.

What is claimed is:

1. A door structure for a vehicle, comprising:
an inner panel positioned on an inner side in a vehicle width direction of a vehicle body;
an outer panel positioned on an outer side of the inner panel in the vehicle width direction; and
a door beam provided between the inner panel and the outer panel in the vehicle width direction, wherein
the door beam comprises:
an arch-shaped beam body in which a center in a longitudinal direction bulges more outward in the vehicle width direction than one end part and another end part attached to the inner panel; and
a bracket interposed between the one end part of the beam body and the inner panel,
a rigidity of the bracket is lower than a rigidity of the beam body, and
at least a portion of the inner panel to which the another end part of the beam body is attached is opposed to a member on a vehicle body side located on the inner side in the vehicle width direction, with a gap in the vehicle width direction being present therebetween.

2. The door structure for a vehicle according to claim 1, wherein
the bracket is a member interposed between a front end part of the beam body and the inner panel,
the bracket comprises:
a first joint surface joined to the inner panel;
a second joint surface to which the front end part of the beam body is joined; and
a connecting surface arranged in a plane in the vehicle width direction of the vehicle body and connecting the first joint surface and the second joint surface, and
the connecting surface is formed in a shape in which a length in the vehicle width direction gradually increases from a front side toward a rear side of the vehicle body.

3. The door structure for a vehicle according to claim 2, wherein
the connecting surface of the bracket is formed in a triangular shape comprising a first side connected to the first joint surface and a second side connected to the second joint surface, and a distance between the first side and the second side gradually increases from the front side toward the rear side of the vehicle body.

4. The door structure for a vehicle according to claim 2, wherein
a reinforcing member which reinforces the second joint surface of the bracket is provided between the second joint surface and the beam body.

5. The door structure for a vehicle according to claim 3, wherein
a reinforcing member which reinforces the second joint surface of the bracket is provided between the second joint surface and the beam body.

6. The door structure for a vehicle according to claim 2, wherein
the front end part of the beam body is a straight part in a straight shape extending in a straight pattern toward the rear side,
a curve part in a curved shape which bulges toward the outer side in the vehicle width direction is connected to a rear side of the front end part in the beam body, and
the bracket is attached to the front end part.

7. The door structure for a vehicle according to claim 6, wherein
at least a portion of the inner panel to which the bracket is attached is opposed to a front pillar which is a member on the vehicle body side located on the inner side in the vehicle width direction, and
the front end part of the beam body is provided at a position opposed to the front pillar via the inner panel.

8. The door structure for a vehicle according to claim 3, wherein
the front end part of the beam body is a straight part in a straight shape extending in a straight pattern toward the rear side,
a curve part in a curved shape which bulges toward the outer side in the vehicle width direction is connected to a rear side of the front end part in the beam body, and
the bracket is attached to the front end part.

9. The door structure for a vehicle according to claim 8, wherein
at least a portion of the inner panel to which the bracket is attached is opposed to a front pillar which is a member on the vehicle body side located on the inner side in the vehicle width direction, and
the front end part of the beam body is provided at a position opposed to the front pillar via the inner panel.

10. The door structure for a vehicle according to claim 4, wherein
the front end part of the beam body is a straight part in a straight shape extending in a straight pattern toward the rear side,
a curve part in a curved shape which bulges toward the outer side in the vehicle width direction is connected to a rear side of the front end part in the beam body, and
the bracket is attached to the front end part.

11. The door structure for a vehicle according to claim 10, wherein
at least a portion of the inner panel to which the bracket is attached is opposed to a front pillar which is a member on the vehicle body side located on the inner side in the vehicle width direction, and
the front end part of the beam body is provided at a position opposed to the front pillar via the inner panel.
